(19) United States
(12) Patent Application Publication
(10) Pub. No.: US 2010/0108512 A1
(43) Pub. Date: May 6, 2010

(54) ELECTROPHORETIC CHIP AND METHOD OF USING THE SAME

(76) Inventor: Wataru Hattori, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/448,558

(22) PCT Filed: Dec. 14, 2007
(86) PCT No.: PCT/JP2007/001400

§ 371 Date: Jun. 25, 2009

(30) Foreign Application Priority Data
Dec. 26, 2006 (JP) 2006-350184

(51) Int. Cl. G01N 27/447

(52) U.S. Cl. 204/452; 204/601

(57) ABSTRACT

A chip 400 is composed of a substrate 401, and a frame component 402 provided on the surface of the substrate 401, so as to be brought into contact with the substrate 401. A flow path 102 which retains a liquid sample, and serves as a trench-type flow path allowing therethrough electrophoretic migration of a sample to be subjected to mass analysis, is configured to use the substrate 401 as the bottom surface, and to use the frame component 402 as the sidewall. The substrate 401 and the frame component 402 are configured to be separable.

### TECHNICAL FIELD

The present invention relates to an electrophoretic chip allowing therein electrophoretic migration of a sample to be subjected to mass analysis, so as to cause isolation in a trench-type flow path, followed by detection by a mass analyzer, and a method of using the same.

### BACKGROUND ART

In recent years, efforts have been made on developing systems which fractionate solutes, such as proteins contained in a sample solution, by capillary electrophoresis using a flow path fabricated on the surface of a microfluidic chip, and then ionize the solutes by scanning with laser along the flow path on the chip using a matrix-assisted laser desorption/ionization mass spectrometer (MALDI-MS), so as to detect the solutes by mass analysis (see Non-Patent Documents 1 to 3, Patent Documents 1, 2). In these systems making use of the electrophoretic chip having the trench-type flow path, the solutes fractionated in the flow path are dried so as not to disturb the state of fractionation, and thus fractionated and dried solutes are added with a solution containing an ionization enhancer called matrix dissolved therein so as to form a matrix crystal having the sample mixed therein, followed by mass analysis. Accordingly, the sample as the solutes is handled in a liquid state, while being dissolved in a solvent, in the process of capillary electrophoresis.

On the other hand, in the process of MALDI-MS, the sample is dried and in a crystallized state together with the matrix. In these systems, it may be preferable to use a flow path having a trench form and configured as an open-top type having no lid structure, that is, a flow path allowing the top surface of the solution to be brought into contact with a gas so as to enable smooth vaporization of the solvent. By adopting this configuration, vapor of the solvent of the sample solution may be discharged through the gas brought into contact with the top surface of the solution, upon completion of the electrophoresis without detaching and attaching the lid, so that the solvent may readily be dried off, and thereby the sample in the liquid state in the process of capillary electrophoresis, and the sample in the dried and crystallized form together with the matrix, to be subjected to MALDI-MS, may readily be handled in a consecutive manner. It may also be easy to fractionate the sample by electrophoresis in the flow path, and then to rapidly heat and dry the solution of the flow path without disturbing the fractionated pattern of the sample; or to freeze the solution immediately after the fractionation of the sample so as to fix the fractionated pattern, and then to lyophilize the solution.

On the other hand, in the general flow path of the non-trench-type, that is, in the flow path closed with a lid and filled with the sample solution, it may not be easy to dry the sample solution in the flow path, so that there is no way but to gradually dry out the solvent from both sides of the flow path. It may therefore be also difficult to dry the solution without disturbing the fractionation pattern of the sample. In addition, the lid may necessarily be removed in the process of mass analysis based on MALDI-MS, because the lid intercepts the laser and also inhibits the ionization, so that it may be difficult to combine the non-trench-type flow path with the mass analyzer, unlike the electrophoretic chip having the trench-type flow path.

The mass analyzer most generally used for mass analysis of macromolecules such as protein is of the time-of-flight type. In the time-of-flight mass analyzer, macromolecules are ionized, and the mass thereof is determined by measuring the length of time before the accelerated ions are detected.

[Non-Patent Document 1] K. Tseng et al., SPIE, vol. 3606 (1999), P. 137-148.

[Non-Patent Document 2] J. Liu et al., Analytical Chemistry, vol. 73, No. 9 (2001), P. 2147-2151

[Non-Patent Document 3] M. Mok et al., Analyst, vol. 129 (2004), P. 109-110

[Patent Document 1] Published Japanese Translation of PCT International Publication for Patent Publication No. 2005-517954

[Patent Document 2] Japanese Patent application No. 2004-177574

### DISCLOSURE OF THE INVENTION

Now, FIG. 11 is a top view schematically illustrating an electrophoretic chip using a trench-type flow path described in Non-Patent Documents 1 to 3, and Patent Documents 1, 2; FIG. 12 is a sectional view of the electrophoretic chip described in Non-Patent Document 1 to 3, and Patent Document 1, taken along line A-A′ in FIG. 11; and FIG. 13 is a sectional view schematically illustrating the electrophoretic chip described in Patent Document 2, taken along line A-A′.

According to Non-Patent Document 1, the sectional dimensions of the flow path (depth×width) is 500 μm×500 μm, and 250 μm×250 μm. According to Non-Patent Document 2, the dimension of flow path is 250 μm or 200 μm deep, and 250 μm or 150 μm wide, and is formed by dicing. According to Non-Patent Document 3, the flow path is formed by pressing platinum wires of 0.007 inches (approximately 180 μm) in diameter against a plastic substrate. According to Patent Document 1, the flow path is formed by pressing platinum wires of 0.005 inches (approximately 130 μm) and 0.007 inches (approximately 180 μm) in diameter against a plastic substrate.

The electrophoretic chips having these trench-type flow paths are configured by entrenching a flow path 102 and reservoirs 103, 104 from the top surface of the chip, so as to prevent a liquid in the reservoirs from flowing into the flow path, and flooding out from the flow path. Alternatively, according to the technique described in Non-Patent Document 3, a capillary configured to suppress leaching of the solution by using a salt bridge is immersed in the reservoir so as to supply an electrode solution, and so as to prevent the electrode solution from flowing into the flow path and from flooding the flow path. As is known from the above, but not detailed in the present invention, the trench-type flow path chip is structurally conceived to suppress flooding of the solution, typically by aligning the level of height of the fluid trap communicated with each other, or by inserting the salt bridge for the case where the levels of height are different.

A chip 100 illustrated in FIG. 11 has the flow path 102 formed on a substrate 101. The geometry of the flow path illustrated herein is an exemplary single straight flow path often used for isoelectric focusing, although there are also known those of cross type, and folk type slightly modified from the cross type. For the purpose of isoelectric focusing, there are further provided the reservoirs 103, 104 for reserving acidic and alkaline electrode solutions, on both ends of the flow path.

In the trench-type flow path 102 illustrated in FIG. 12, which is described in Non-Patent Documents 1 to 3, and Patent Document 1, a depth of trench of as deep as 100 μm or more has caused flight of the sample from the sidewall of the trench into a detector, and has inevitably caused degradation in accuracy of mass analysis. By making the trench as deep as described in the above, the amount of drying of the solvent in the process of capillary electrophoresis may be suppressed to a level sufficiently smaller than the amount of solvent in the entire flow path, so as to ensure a function of capillary. On the other hand, in the trench-type electrophoretic chip described in Patent Document 2, the depth of the trench-type flow path 102 is as shallow as 10 μm, enough to suppress degradation in accuracy of mass analysis. The shallow trench structure is configured to suppress drying of the solvent in the process of capillary electrophoresis, and thereby to ensure a function as a capillary, by adjusting a cylinder array structure 301, which is a specially-designed microstructure in the flow path, and vapor pressure around the chip.

The smallness of the capacity of flow path in this case has, however, allowed only a small chargeable amount of sample, and has consequently resulted in a poor sensitivity of sample detection. In other words, the trench-type electrophoretic chips described in Non-Patent Documents 1 to 3, and Patent Documents 1, 2 have been suffering from a trade-off problem in that deepening of the flow path has resulted in higher sensitivity of sample detection but poorer accuracy of mass analysis, whereas shallowing of the flow path has resulted in higher accuracy of mass analysis but poorer sensitivity of detection.

An exemplary object of the invention is to provide a electrophoretic chip capable of solving the trade-off relation between the sensitivity of sample detection and accuracy of mass analysis.

According to an exemplary aspect of the invention, there is provided an electrophoretic chip having a trench-type flow path allowing therethrough electrophoretic migration of a sample to be subjected to mass analysis, the chip includes: a substrate forming the bottom surface of the flow path; and a frame component provided on the substrate so as to form the sidewall of the flow path, wherein the frame component has at least a part of opening in the flow path, and the substrate and the frame component are separable.

According to another exemplary aspect of invention, there is provided also an electrophoretic chip having a trench-type flow path allowing therethrough electrophoretic migration of a sample to be subjected to mass analysis, the chip includes: a substrate forming the bottom surface of the flow path; and a frame component provided on the substrate so as to form the sidewall of the flow path, the frame component is formed by using a gel-like material containing either one of silicon polymer and acryl polymer, and the substrate and the frame component are separable.

According to another exemplary aspect of invention, there is provided still also a method of using the electrophoretic chip of the one exemplary invention as a target plate for mass analysis, the method includes: a first step which includes: injecting a solution of the sample into the flow path; applying voltage along the flow path to thereby fractionate the solution of the sample in the flow path; and drying the sample, and a second step setting the sample to a laser desorption/ionization mass spectrometer, irradiating laser to the sample while moving the bottom surface of the flow path relative to the region of laser irradiation, to thereby detect mass of the sample, wherein the first step is carried out while combining the substrate and the frame component, the second step is carried out while detaching the frame component from the substrate, and the first step is carried out so as to bring the top surface of the solution of the sample retained by the flow path into contact with a gas.

According to the exemplary aspects of invention, there is provided an electrophoretic chip capable of solving the trade-off relation between the sensitivity of sample detection and accuracy of mass analysis.

### BRIEF DESCRIPTION OF THE DRAWINGS

FIG. 1 is a top view schematically illustrating a configuration of an electrophoretic chip according to a first exemplary embodiment.

FIG. 2 is a sectional view of the electrophoretic chip according to the first exemplary embodiment illustrated in FIG. 1, taken along line B-B′.

FIG. 3 is a perspective view schematically illustrating the electrophoretic chip according to the first exemplary embodiment.

FIG. 4 is a sectional view of a modified example of the electrophoretic chip according to the first exemplary embodiment, taken along line B-B′.

FIG. 5 is 1 sectional view of another modified example of the electrophoretic chip according to the first exemplary embodiment, taken along line B-B′.

FIG. 6 is a top view schematically illustrating an electrophoretic chip according to a second exemplary embodiment.

FIG. 7 is a sectional view of the electrophoretic chip according to the second exemplary embodiment illustrated in FIG. 6, taken along line C-C′.

FIG. 8 is a drawing illustrating a cylinder array structure on the bottom surface of the flow path of the electrophoretic chip according to the second exemplary embodiment.

FIG. 9 is a drawing illustrating another cylinder array structure on the bottom surface of the flow path of the electrophoretic chip according to the second exemplary embodiment.

FIG. 10 is a drawing illustrating another cylinder array structure on the bottom surface of the flow path of the electrophoretic chip according to the second exemplary embodiment.

FIG. 11 is a top view schematically illustrating a configuration of an electrophoretic chip according to a conventional example.

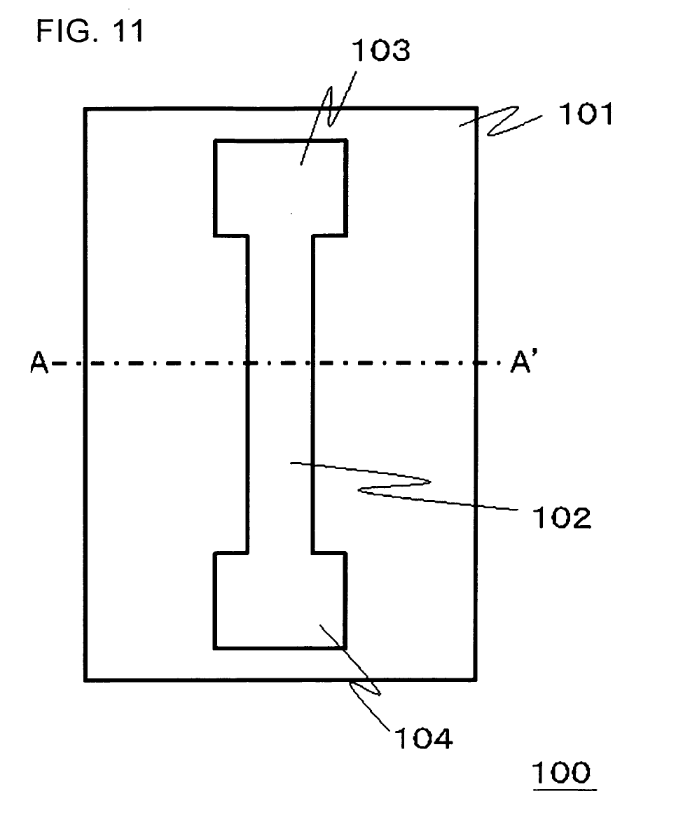

FIG. 12 is a sectional view of the electrophoretic chip according to the relational example illustrated in FIG. 11, taken along line A-A′.

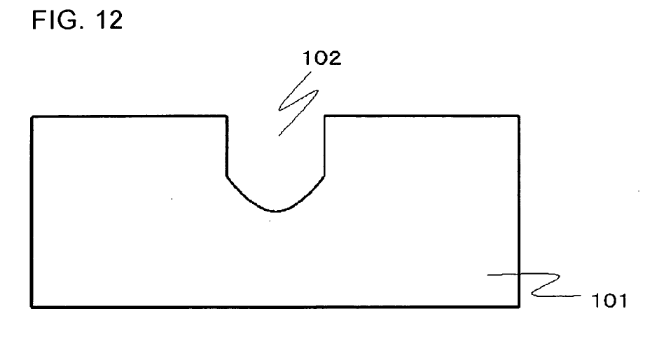

FIG. 13 is a sectional view of the electrophoretic chip according to the relational example illustrated in FIG. 11, taken along line A-A′.

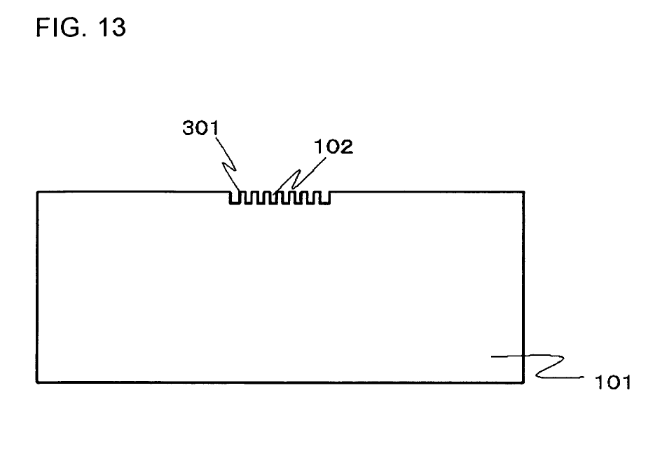

### EXEMPLARY EMBODIMENT

### First Exemplary Embodiment

First exemplary embodiment of the present invention will be explained below, referring to the attached drawings. Note that any similar constituents will be given with similar reference numerals, and explanations therefor will not be repeated.

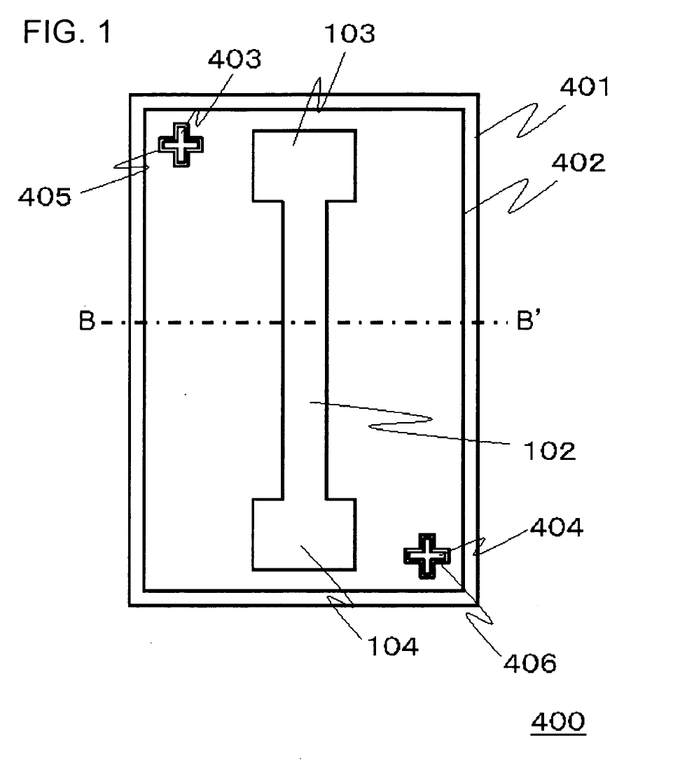

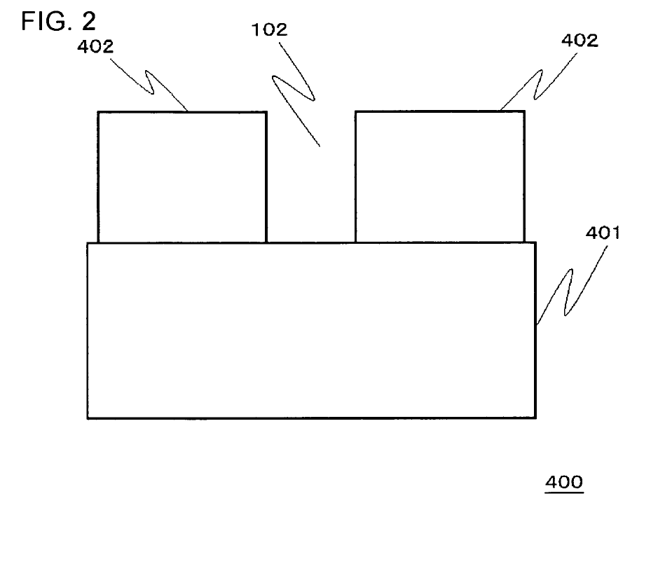

FIG. 1 is a top view schematically illustrating a configuration of an electrophoretic chip according to the first exemplary embodiment. FIG. 2 is a sectional view taken along line B-B′ in FIG. 1. This exemplary embodiment relates to an electrophoretic chip (occasionally referred to as “chip”, hereinafter) 400, having a trench-type flow path (channel) 102 allowing therethrough electrophoretic migration of a sample to be subjected to mass analysis. The chip 400 contains a substrate 401 forming the bottom surface of the flow path 102, and a frame component 402 provided on the substrate 401 so as to form the sidewall of the flow path 102, wherein the frame component 402 has at least a part of openings in the flow path, and the substrate 401 and the frame component 402 are separable.

Specifically, the chip 400 illustrated in FIG. 1 and FIG. 2 is formed by the substrate 401, and the frame component 402 provided on the surface of the substrate 401. The flow path 102 serves as the trench-type flow path allowing therethrough electrophoretic migration of a sample to be subjected to mass analysis, and is configured so that the substrate 401 composes the bottom surface thereof, and the frame component 402 composes the sidewall. Furthermore, the substrate 401 and the frame component 402 are configured to be separable. The flow path 102 in the first exemplary embodiment is configured to be opened over the entire portion of the top surface thereof.

The chip 400 has reservoirs 103, 104 having a fluid trap structure. The sidewalls of the reservoirs 103, 104 are formed by the frame component 402, and the bottom surfaces of the reservoirs are formed by the substrate 401. The reservoirs 103, 104 are provided on both ends of the flow path 102.

The chip 400 may be composed of an electric insulator exhibiting dielectric strength against applied voltage. Meanwhile, at least a part of either one of the frame component 402 and the substrate 401 may be composed of a material having adhesiveness with respect to the other. The material having adhesiveness may be a gel-like material containing either one of a silicon polymer and an acryl polymer.

The substrate 401 may be configured by a flat plate component. For example, it may be configured by a glass material such as quartz glass. Alternatively, a substrate composed of resin such as acryl may be adoptable. Still alternatively, a silicon substrate or the like hydrophilized by forming an oxide film on the surface thereof, and thereby imparted with electric insulating property may be adoptable. The frame component 402 may be composed of a material having adhesiveness to the substrate 401. For example, it may be composed of a gel-like material composed of a silicon polymer such as PDMS (polydimethyl siloxane), or an acryl polymer. Conversely, the substrate 401 may be configured by a material having adhesiveness to the frame component 402, and the frame component 402 may be composed of a flat plate component. Anyway, it may be good enough that the surfaces to be bonded of both of the frame component 402 and the substrate 401 may be brought into close contact with the aid of the above-described material having adhesiveness, so as to allow handling of a sample solution in the process of electrophoresis, and that the frame component 402 and the substrate 401 may be configured to be separable when the sample is set to a laser desorption/ionization mass spectrometer.

The surface of the substrate 401 forming the bottom surface of the flow path 102 may be preferably lyophilic. For example, a material composing the substrate may be such as exhibiting lyophilicity. Even for the case where the material exhibits lyphobicity, PDMS, glass or the like, for example may be provided with a hydrophilic coating such as polyacrylamide using a primer or a silane coupling agent. In this way, the bottom surface of the flow path 102 may be turned into lyophilic.

On the other hand, the sidewall of the flow path 102 formed by the frame component 402 may preferably be lyophobic. Since PDMS exhibits hydrophobicity against aqueous solution, the frame component 402 may be composed of a material such as PDMS. Alternatively, the surface of the frame component 402 may be coated with a fluorine-containing resin film. In this way, the sidewall of the flow path 102 consequently has a high level of lyophobicity.

A maximum difference of height of the surface of the substrate 401 forming the bottom surface of the flow path 102 may be preferably adjusted to 100 μm or smaller, and more preferably 50 μm or smaller. The maximum difference of height may be measured using a stylus profilometer or a laser microscope.

Either one of the substrate 401 and the frame component 402 may have alignment marks used for alignment between the substrate 401 and the frame component 402. For example, the substrate 401 is provided with alignment marks 403, 404, and the frame component 402 is provided with alignment marks 405, 406.

Each alignment mark may be composed of a pair of projection and hole engageable with each other. In this case, the projection may be provided to either one of the frame component 402 and the substrate 401. Furthermore, the hole may be provided to the other corresponding to the projection.

Specifically, the alignment marks 403, 405, and the alignment marks 404, 406 may be configured as pairs of projections and holes engageable with each other. The hole may be a throughhole, or may be a recess. For an exemplary case where the frame component 402 is provided with projection-type alignment marks 405, 406 formed thereon, the substrate 401 may be provided with throughole-type alignment marks 403, 404 formed therein. Alternatively, either one of the substrate 401 and the frame component 402 may be provided with projection-type alignment marks 403, 404 formed thereon, and the other may be provided with recess-type alignment marks 405, 406 formed therein. In this case, even if the frame component 402 is opaque, the substrate 401 and the frame component 402 may be bonded if the substrate 401 is composed of a transparent material, by alignment through the substrate from the back side thereof. Alternatively, the projection-type alignment marks 403, 406 and the throughhole-type or recess-type alignment marks 404, 405 may be formed, or still alternatively the projection-like alignment marks 404, 405 and the throughhole-type or recess-type alignment marks 403, 406 may be formed.

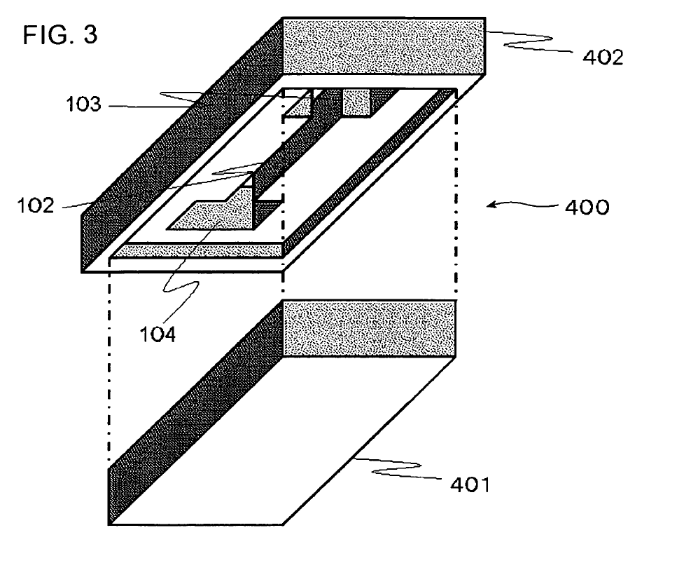

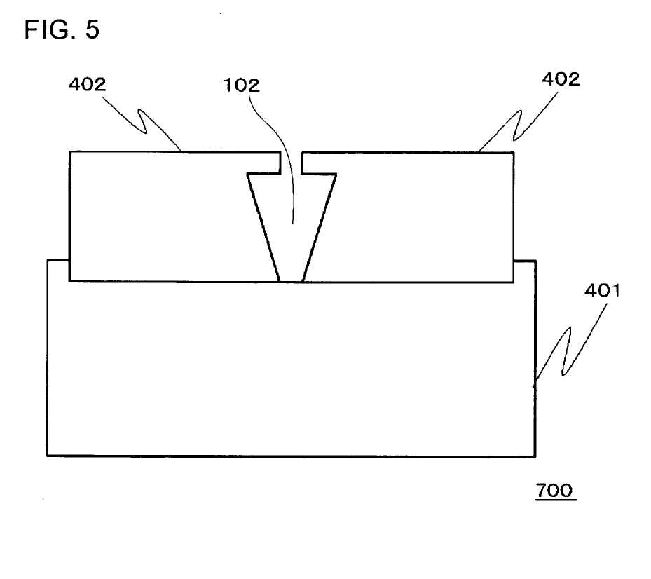

The chip 400 may be configured also such that either one of the frame component 402 and the substrate 401 is engageable with the other. More specifically, as illustrated in FIG. 3, the substrate 401 may be configured to fit into the frame component 402 while being guided by the contour of the chip 400. Alternatively, as represented by a chip 700 as illustrated in FIG. 5 described later, a frame may be formed on the substrate 401, and the frame component 402 may be configured to be fit into the frame.

A major purpose of using the frame component 402 is to form the sidewall of the flow path 102, where there may be variations in the geometry of the sidewall.

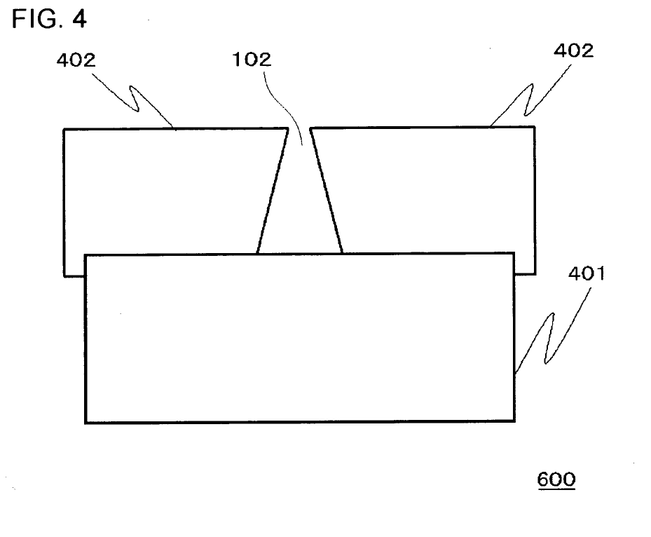

For example, a chip 600 illustrated in FIG. 4 has a taper on the sidewall of the flow path 102 configured by the frame component 402. Alternatively, the chip 700 illustrated in FIG. 5 has the flow path 102 with a penthouse formed in the upper portion thereof, while making the taper narrowed towards the bottom surface of the flow path 102.

Referring now back to FIG. 1, a method of using the chip 400 will be explained below. The method of using relates to a method of using the chip 400 as a target plate for mass analysis. The method includes: a first step which includes injecting a solution of the sample into the flow path 102, applying voltage along the flow path 102 to thereby fractionate the solution of the sample in the flow path 102, and drying the sample; and a second step setting the sample to a laser desorption/ionization mass spectrometer, irradiating laser to the sample while moving the bottom surface of the flow path 102 relative to the region of laser irradiation, to thereby detect mass of the sample. The first step is carried out while combining the substrate 401 and the frame component 402. Furthermore, the first step is carried out also so as to bring the top surface of the solution of the sample retained by the flow path 102 into contact with a gas. The second step is carried out while detaching the frame component 402 from the substrate 401.

Specifically, the frame component 402 is provided on the substrate 401. The frame component 402 is kept in a state of being adherent to the substrate 401 strongly enough to suppress leaching of the solution, and being readily separable. In the flow path 102 of the chip 400, a solution containing a sample to be subjected to mass analysis dissolved therein (sample solution) is injected. The sample solution may possibly be an aqueous solution containing peptides or proteins dissolved therein. The solution may be added with an ampholite which produces hydrogen ion concentration gradient under applied voltage. Since the flow path 102 has an open-top structure, the sample solution may be brought into contact with a gas.

Next, acidic and alkaline electrode solutions are introduced into the reservoirs 103, 104. Thereafter, voltage is applied along the flow path 102 via the electrode solutions. In general, the electric field intensity applied in the capillary isoelectric focusing falls in the range from 600 to 800 V/cm. The end point of the isoelectric focusing may be determined based on a decreasing tendency of current, by measuring current at the same time with the application of voltage. The sample is fractionated in the flow path 102 by carrying out the electrophoresis as described in the above, the solvent is vaporized off through the gas brought into contact with the top surface of the solution, making use of the open-top structure of the flow path 102 to thereby dry up the sample solution, the dried sample is added with a solution (matrix solution) of an ionization enhancer called matrix typically by using a spray, dispenser, or ink-jet solution dropper, and then further dried.

Thereafter, the frame component 402 is detached to expose the bottom surface of the flow path 102, and the substrate 401 is set to a MALDI-MS. Laser is then irradiated while moving the bottom surface of the flow path relative to the region of laser irradiation, and mass analysis is carried out.

Effects of this exemplary embodiment will be explained below, referring to FIG. 1. In the electrophoretic chip 400, the trench-type flow path 102, allowing therethrough electrophoretic migration of a sample to be subjected to mass analysis, is composed of at least two components, that is, the frame component 402 and the substrate 401. The substrate 401 forms the bottom surface of the flow path 102, and the frame component 402 forms the sidewall of the flow path 102. Accordingly, the depth of the flow path 102, affective to the sensitivity of sample detection in the process of electrophoresis, is determined by the height of the sidewall formed by the frame component 402.

The substrate 401 and the frame component 402 are separable, and the frame component 402 may be detached after electrophoresis. After the frame component 402 is detached, only the substrate 401 is set to a laser desorption/ionization mass spectrometer, wherein the irregularity which resides in the flow path affective to the accuracy of mass analysis may be ascribable only to the irregularity on the substrate.

Accordingly, the amount of sample to be subjected to electrophoresis, which affects the accuracy of sample detection, may be determined by the frame component 402, and the accuracy of mass analysis may be determined by the irregularity on the substrate, respectively in an independent manner. As a consequence, a trade-off relation between the sensitivity of sample detection and the accuracy of mass analysis may be resolved.

Alternatively, the electrophoretic chip 400 of this exemplary embodiment is configured using at least two components, that is, the frame component 402 forming the sidewall of the flow path 102, and the substrate 401 forming the bottom surface of the flow path 102, by bonding the frame component 402 in contact with the substrate 401, while keeping them in a detachable manner after electrophoresis. Accordingly, the depth of the flow trench-type flow path affective to the sensitivity of sample detection in the process of electrophoresis may be determined by the height of the sidewall determined by the frame component 402.

The level of height of the solution, which depends on the height of the sidewall, may be maximized so far as the capillary electrophoresis will not adversely be affected. For example, as a condition allowing only a sufficiently small amount of vaporization of the solution affected by Joule heat, a level of height of up to 1 mm may be permissible, although depending typically on the intensity of electric field to be applied, or a cooling mechanism of the solution in the flow path. Thereafter, the frame component 402 is detached from the substrate 401 at least before setting to the laser desorption/ionization mass spectrometer. What is set to the laser desorption/ionization mass spectrometer is the substrate 401 only, so that the irregularity in the flow path affective to the accuracy of mass analyses may be determined only by the irregularity on the substrate 401, wherein the irregularity may be reduced to a sufficiently low level not affective to the accuracy of mass analysis.

As a consequence, the sensitivity of sample detection is determined by the frame component 402, and the accuracy of mass analysis is determined by the substrate 401, so that the trade-off relation between the sensitivity of sample detection and the accuracy of mass analysis may be resolved. More specifically, as compared with a conventional electrophoretic chip having a flow path of as deep as 100 μm or more, the electrophoretic chip 400 of this exemplary embodiment may ensure the level of height of solution to as high as 1 mm, even under the same width of the flow path. Accordingly, the amount of solution may be increased by ten times, and thereby the sensitivity of detection of proteins and so forth may correspondingly be improved.

The chip 400 in the process of mass analysis may be configured by the flat substrate 401 only, after being separated from the frame component 402. For example, by using a commercially-available glass substrate, a difference of height of ±20 μm may be guaranteed over the entire surface of the substrate.

The difference of height may readily be adjustable within the range of 100 μm or smaller, after considering the position of laser irradiation, even when the substrate is further processed, or typically etched, on the surface thereof, to typically form a cylindrical component array having a difference of height of 10 to 30 μm or around.

On the other hand, it may be difficult for the conventional chip, having the flow path of as deep as 100 μm or more, to ensure a mass error of 1/10000 or less due to its large depth. For example, the conventional examples describe the width of flow path of 130, 150, 180, 250 and 500 μm, whereas the diameter of laser spot of MALDI-MS is exemplified as approximately 100 μm to 200 μm, and also as approximately 700 μm for larger one. For the purpose of carrying out mass analysis without wasting the sample, and of obtaining high sensitivity, the laser is generally irradiated over the flow path while finely positioning the laser so as to irradiate the entire surface, and thereby mass spectrum is obtained.

Even if an internal standard sample is used for detecting proteins and so forth, aiming at minimizing influences of irregularity of the substrate, irradiation of the laser to any region containing the sidewall of the flow path inevitably and readily results in difference of height, in the site of generation of ions, ascribable to the geometry of the flow path, because the diameter of laser spot and the width of flow path do not so largely differ. Accordingly, a difference of height exceeding 100 μm may readily occur, and therefore the mass error ascribable thereto will not be reduced, unless otherwise a mass analyzer having an extremely small laser spot is developed.

In the electrophoretic chip 400 of this exemplary embodiment, at least a part of either one of the frame component 402 forming the sidewall of the flow path 102 and the substrate 401 forming the bottom surface of the flow path 102 may be formed using a material having adhesiveness with respect to the other, such as a gel-like material mainly composed of a silicon polymer represented by PDMS, or an acryl polymer. This sort of gel-like material may tightly bond the substrate 401 and the frame component 402, by virtue of its large adhesiveness. Accordingly, the solution may be retained in the flow path 102, and thereby the sample solution may be prevented from leaching in the process of electrophoresis.

In addition, by disposing such material having adhesiveness at least at the surfaces of contact of the frame component 402 and the substrate 401, a configuration realized herein may be such that the frame component 402 and the substrate 401 are bonded, and that the frame component 402 may be detachable from the substrate 401.

The bottom surface of the flow path 102, if remained lyophobic, may make the liquid filled in the flow path 102 more likely to remain therein due to adhesion of bubbles. The problem may therefore be avoidable, by configuring the bottom surface of the flow path 102 so as to exhibit lyophilicity.

The sidewall of the flow path 102 formed by the frame component 402 may be made more repellent to liquid, by being configured to exhibit lyophobicity. Accordingly, solutes may be prevented from adhering much to the sidewall, when the solution is dried by heating after electrophoresis.

Alternatively, a monomolecular layer typically composed of polyacrylamide may be coated on the frame component 402 composed of PDMS, or on the surface of glass composing the substrate 401. In this way, electroosmotic flow or adsorption of proteins and so forth may be suppressed in the process of electrophoresis, and thereby the end point may more readily be judged.

According to the electrophoretic chip 400 of this exemplary embodiment, errors in the mass analysis ascribable to irregularities on the bottom surface of the flow path may be suppressed to a low level, by suppressing the maximum difference of height of the bottom surface of the flow path to 100 μm or smaller.

Mass analysis of macromolecules such as proteins and so forth using a time-of-flight MALDI-MS may be carried out by irradiating laser onto macromolecules and so forth so as to ionize them, and by measuring length of time before the accelerated ions are detected. At that time, any positional variation in ionization of the macromolecular sample in the direction of axis of flight may be causative of error in mass analysis.

In the time-of-flight MALDI-MS at present, the range of flight of ions is generally 1 m or around, and the mass error is at a level of approximately 1/10000. In other words, positional variations of ionization of macromolecular samples are necessarily suppressed to 1/10000 of 1 m, that is, approximately 100 μm or smaller.

Positional variations of ionization of macromolecular samples may therefore be suppressed to 100 μm or smaller, by controlling the maximum difference of height of the bottom surface of the flow path 102 to 100 μm or smaller. In this way, the accuracy of mass analysis may be prevented from degrading.

Moreover, by adjusting the maximum difference of height to 1/20000 of the accuracy of mass analysis, that is, 50 μm or smaller, any degradation in the accuracy of mass analysis ascribable to other factors may be allowable to a certain degree, and thereby a chip excellent in the accuracy of mass analysis may be realized.

A smaller maximum difference of height of the bottom surface of the flow path 102 more effectively suppresses positional variations of ionization of macromolecular samples, and thereby ensures highly accurate mass analysis. Accordingly, the maximum difference of height of the bottom surface of the flow path as large as 10 μm may be allowable.

Meanwhile, in the electrophoretic chip 400 of this exemplary embodiment, by providing alignment marks 403 to 406 used for aligning the frame component 402 and the substrate 401, the sidewall of the flow path 102 formed by the frame component 902 and the bottom surface of the flow path 102 formed by the substrate 401 may precisely be combined.

By using the alignment marks 403 to 406 provided on the substrate 401, the region of the substrate 401 previously forming the bottom surface of the flow path 102 may be recognizable based on the positional relation with respect to the alignment marks 403, 404, even if the substrate 401 was detached from the frame component 402 after electrophoresis. Accordingly, a matrix solution may be added using a spray, dispenser or the like to the region of the substrate 401, previously forming the bottom surface of the flow path 102, after the frame component 402 was detached.

Furthermore, By using the alignment marks 403, 404 on the substrate 401, a position of laser irradiation and the bottom surface of the flow path to be irradiated by laser may be alignable, even after the substrate is set to a laser desorption/ionization mass spectrometer, and thereby mass analysis may efficiently be carried out along the bottom surface of the flow path 102.

Alternatively, by adopting the configuration allowing either one of the frame component 402 and the substrate 401 to be engageable with the other, the frame component 402 and the substrate 401 may be positionally aligned, and thereby the sidewall of the flow path 102 formed by the frame component 402 and the bottom surface of the flow path formed by the substrate 401 may precisely be combined. In this configuration, since the positional relation of the flow path 102 with respect to the contour of the chip may be produced in a sufficiently exact manner, so that positions of the flow path 102 and the reservoirs 103, 104 may be determined by fitting the substrate 401 into the frame component 402. In addition, the contour of the substrate 401 may be used as a reference also in the process of addition of the matrix or setting onto the MALDI-MS.

Projection, or a structure allowing either one of the frame component and the substrate to engage with the other as described in the above, aiming at combining the substrate 401 and the frame component 402, are advantageous in that they may readily be manufacturable.

Meanwhile, as illustrated in FIG. 4, by providing a taper to the sidewall of the flow path 102 formed by the frame component 402, the solution contained in the flow path may be less likely to splash out from the opened top thereof, proving the structure as desirable from the viewpoint of bio-safety. Moreover as illustrated in FIG. 5, by providing a penthouse to the upper portion of the flow path 102, the solution may be suppressed from splashing out. Since the taper is reversely provided so as to be narrowed towards the bottom surface of the flow path 102, so that the sample may be condensed when the sample solution is dried after electrophoresis.

### Second Exemplary Embodiment

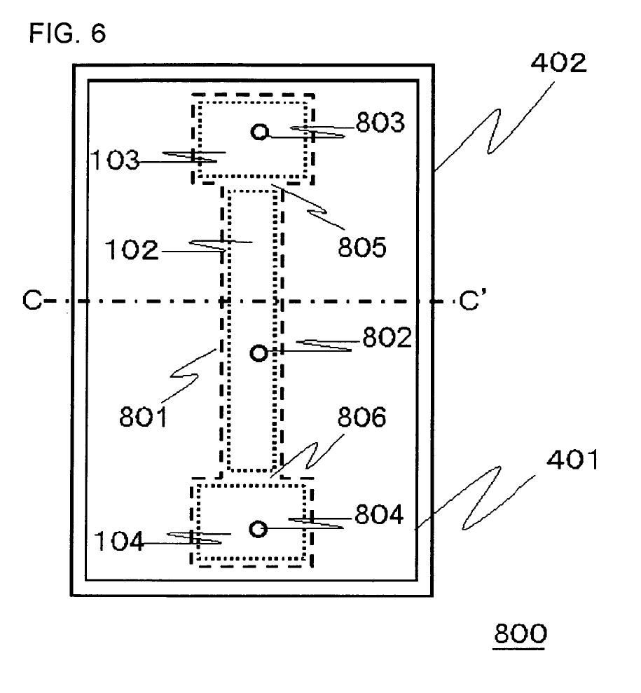

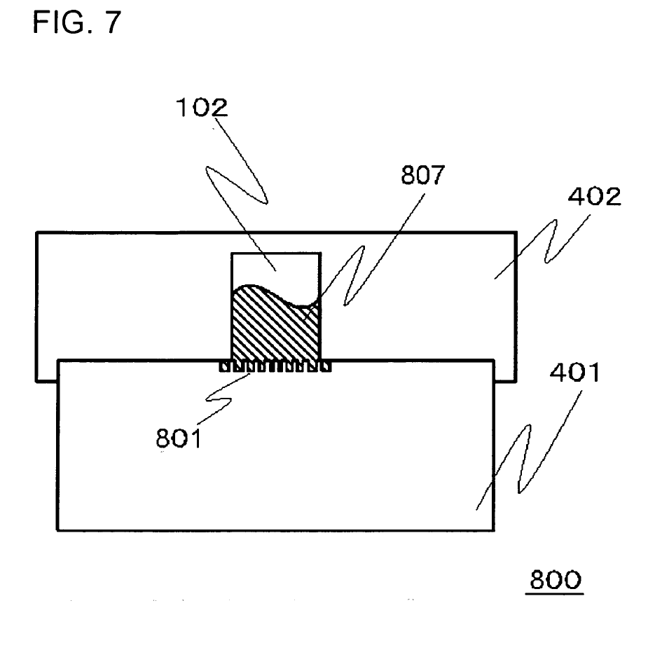

Next, a second exemplary embodiment of the present invention will be explained. FIG. 6 is a top view illustrating a chip 800 having a cylinder array structure 801 provided so as to be laid over the entire regions of the bottom surfaces of the flow path 102 and the reservoirs 103, 104 having a fluid trap structure, as indicated by a broken line. A sectional view taken along line C-C′ is illustrated in FIG. 7.

The chip 800 contains the substrate 401 forming the bottom surface of the flow path 102, and the frame component 402 provided on the substrate 401 and forming the sidewall of the flow path 102, wherein the frame component 402 has holes 802 to 804 formed in the flow path 102, and the substrate 401 and the frame component 402 are separable.

Specifically, the chip 800 illustrated in FIG. 6 and FIG. 7 is composed of the substrate 401, and the frame component 402 provided over the substrate 401. The flow path 102 serves as a trench-type flow path allowing therethrough electrophoretic migration of a solution of sample to be subjected to mass analysis, the bottom surface of which being formed by the substrate 401, and the sidewall of which being formed by the frame component 402. The substrate 401 and the frame component 402 are configured to be separable.

Furthermore, the electrophoretic chip of this exemplary embodiment is configured so as to fit the frame component 402 to the substrate 401, referring to the contour of the chip 800. And the frame component 402 has a recessed structure opened downward in the regions thereof indicated by the broken lines, wherein the flow path 102 and the reservoirs 103, 104 are formed. Furthermore, the recessed structure of the frame component 402 is partitioned respectively by diaphragms 805, 806. Additionally, the frame component 402 has the holes 802, 803, 804 allowing therethrough communication respectively with the flow path 102 and the reservoirs 103, 104, wherein the individual holes are provided through the frame component 402 so as to be opened at the top.

The substrate 401 is configured by a flat plate component, typically a quartz glass plate. Alternatively, a substrate composed of resin such as acryl may be adoptable. Still alternatively, a silicon substrate hydrophilized by forming an oxide film on the surface thereof, and thereby imparted with electric insulating property may be adoptable. The frame component 402 may be composed of a material having adhesiveness to the substrate 401. For example, it may be composed of a gel-like material such as PDMS, or silicon rubber. Conversely, the substrate 401 may be configured by a gel-like material, and the frame component 402 may be composed of a flat plate component. Anyway, it is good enough that the surfaces to be bonded of both of the component 402 and the substrate 401 may be brought into close contact, and may be separable.

The surface of the substrate 401 forming the bottom surface of the flow path 102 may be lyophilic. For example, PDMS, glass or the like may be provided with a hydrophilic coating such as polyacrylamide using a primer or a silane coupling agent. In this way, the bottom surface of the flow path 102 may be turned into lyophilic.

On the other hand, the sidewall of the flow path 102 formed by the frame component 402 may preferably be lyophobic. Since PDMS exhibits hydrophobicity against aqueous solution, the frame component 402 may be composed of a material such as PDMS. Alternatively, the surface of the frame component 402 may be coated with a fluorine-containing resin film. In this way, the sidewall of the flow path 102 consequently has a high level of hydrophobicity.

The chip 800 has the reservoirs 103, 104 adjacent to the flow path 102, the frame component 402 forms the sidewalls of the reservoirs 103, 104, the substrate 401 forms the bottom surface of the reservoirs 103, 104, and the reservoirs 103, 104 and the flow path 102 are communicated with each other through the cylindrical components arrays (cylinder array structure 801).

The maximum difference of height of the bottom surface of the flow path 102 may be adjusted to 100 μm or smaller. The region indicated by the broken line in FIG. 6 has the cylinder array structure 801 formed therein. The cylinder array structure 801 is formed by arranging a plurality of cylindrical components on the bottom surface of the flow path 102. Alternatively, the cylindrical components may be arranged so as to adjust the maximum difference of height to 100 μm or smaller, more preferably 50 μm or smaller, and still more preferably 10 to 30 μm. The cylindrical components may contain those different from each other in the size and geometry. The cylindrical components may be arranged also according to different densities. The cylinder array structure 801 may be configured to exhibit hydrophilicity.

The chip 800 is provided with the reservoirs 103, 104 which configure a fluid trap structure in adjacent to the flow path 102. The frame component 402 forms the sidewall of the reservoirs 103, 104, and the substrate 401 forms the bottom surface of the reservoirs 103, 104. And, the reservoirs 103, 104 and the flow path 102 communicate with each other through the cylinder array structure 801.

Next, a method of using the chip 800 will be explained below. The frame component 402 is provided on the substrate 401. The frame component 402 is kept in a state of being adherent to the substrate 401 strongly enough to suppress leaching of the solution, and being readily separable. In the flow path 102 of the chip 800, a sample solution 807 is injected.

The sample solution 807 may possibly be an aqueous solution having peptides or proteins dissolved therein. The solution may be added with an ampholite which produces hydrogen ion concentration gradient under applied voltage. The sample solution 807 and electrode solutions to be filled in the flow path 102 and the reservoirs 103, 104 may be introduced through the holes 802, 803 and 804, respectively. Alternatively, If the frame component 402 is made of a gel-like material such as PDMS, the solutions may be introduced by piercing it from the top using a syringe. When the sample is introduced using a syringe, a needle is allowed to penetrate from the top of the flow path 102.

As described later, by making the region having the cylinder array structure 801 formed therein super-hydrophilic strongly enough to inhibit thereon formation of water drops, the sample solution 807 introduced using a syringe is brought into a state of infinitely spreading over the region having the cylinder array structure 801 formed therein. As a consequence, the sample solution 807 may infiltrate into the portions below the diaphragms 805, 806 of the frame component and may reach the bottom surface of the reservoirs 103, 104, and may thereby be brought into contact with the electrode solutions.

However, by the diaphragms 805, 806, and by a bottle-neck formed by the cylinder array structure 801, only a limited region is allowed for contact between the sample solution in the flow path 102 and the electrode solutions in the reservoirs 103, 104, thereby the mixing of sample solution 807 with the electrode solutions may be suppressed. In other words, an effect resemble to a salt bridge may be realized by the diaphragms 805, 806 and the cylinder array structure 801.

At that time, since the opened-top structure of the sample solution 807 is adopted herein, so that the top surface of the sample solution 807 is inevitably brought into contact with a gas. The acidic and alkaline electrode solutions are introduced similarly using a syringe, by sticking the needle from the top of the reservoirs 103, 104 and from the top of the flow path 102 so as to penetrate therethrough. Thereafter, voltage is applied through the electrode solutions along the flow path 102. The electric field intensity applied in the capillary isoelectric focusing generally falls in the range from 600 to 800 V/cm. The end point of the isoelectric focusing may be determined based on a decreasing tendency of current, by measuring current started at the same time the voltage is begun to apply.

After the sample is electrophoretically fractionated in the flow path 102 as described in the above, the solvent is allowed to evaporate through the gas brought into contact with the top surface of the sample solution 807 retained by the flow path 102 to thereby dry up the sample. And then, The sample is added with a matrix solution, and is further dried.

Thereafter, the frame component 402 is detached so as to expose the bottom surface of the flow path 102, the substrate 401 is set to the MALDI-MS, and laser is irradiated for mass analysis, while moving the bottom surface of the flow path 102 relative to the region of laser irradiation, to thereby obtain a profile of proteins, peptides, and so forth.

Effects of this exemplary embodiment will be explained below, referring to FIG. 6.

A material having adhesiveness, for example, a gel-like material such as PDMS, may be used for the frame component 402. PDMS expresses adhesiveness with respect to flat glass surface. Accordingly, by forming the frame component 402 using PDMS and by forming the substrate 401 using a flat glass plate, the substrate 401 and the frame component 402 may strongly be adhered. In this way, leaching of the solution may be suppressed. Also they may readily be separable.

The bottom surface of the flow path 102, if conditioned to be lyophobic, may readily catch bubbles and allow them to stay thereon, when the flow path 102 is filled with the solution. Accordingly, the problem may be avoidable, if the bottom surface of the flow path 102 is configured to be lyophilic.

The sidewall of the flow path 102 formed by the frame component 402 may be made more repellent to liquid, if it is configured to be lyophobic. Accordingly, the solute may be prevented from adhering much on the sidewall, if the post-electrophoretic drying of the solvent is proceeded under heating.

Alternatively, a monomolecular layer of polyacrylamide, for example, may be coated on the frame component 402 composed of PDMS or on the surface of glass composing the substrate 401. In this way, an electroosmotic flow or adsorption of proteins and so forth may be suppressed in the process of electrophoresis, and thereby the end point may more readily be judged.

The electrophoretic chip of this exemplary embodiment is configured so as to fit the frame component 402 to the substrate 401, referring to the contour of the chip 800. By virtue of this configuration, the frame component 402 and the substrate 401 may be alignable, and thereby the sidewall of the flow path 102 formed by the frame component 402 and the bottom surface of the flow path 102 formed by the substrate 401 may precisely be combined.

In this configuration, since the positional relation of the flow path 102 relative to the contour of the chip 800 may be determined in a sufficiently accurate manner, the flow path 102 and the reservoirs 103, 104 may accurately be positioned only by fitting the substrate 401 into the frame component 402. Also addition of the matrix, and setting to the MALDI-MS may be proceeded, referring to the contour of the substrate.

Meanwhile, on the substrate 401 in this exemplary embodiment, there is provided the cylinder array structure 801 on the bottom surface of the flow path 102. By virtue of this configuration, the frame component 402 and the substrate 401 may be aligned while making the holes 802, 803, 804 of the flow path 102 formed by the frame component 402 corresponded to the cylinder array structure 801, and thereby the side wall of the flow path 102 formed by the frame component 402 and the bottom surface of the flow path 102 formed by the substrate 401 may precisely be combined.

In other words, the cylinder array structure 801 serves as an alignment mark used for aligning the frame component 402 with the substrate 401. Furthermore, since the region of the flow path 102 may be discriminated by the cylinder array structure 801, so that the position of laser irradiation and the bottom surface of the flow path 201 to be irradiated with laser may be aligned, even after setting onto the laser desorption/ionization mass spectrometer, and thereby mass analysis may be proceeded along the flow path 102 in an efficient manner.

The frame component 402 in this exemplary embodiment may have the holes 802 to 804, as an example of the open-top structure. The holes 802 to 804 not only allow therethrough injection of the sample into the flow path 102, but also allow therethrough evacuation of the flow path and the reservoirs after electrophoresis so as to keep them under reduced pressure. The drying may therefore be accelerated.

On the other hand, the holes may be configured to be opened and closed with a valve after a tube was drawn out, or may be closed with a tape, in the process of electrophoresis. In this way, drying of the solvent in the process of electrophoresis may be avoidable. At this point, if the space occupied by the a gas above the top surface of the solution is made smaller, the vapor pressure may more readily elevate, and thereby an unexpected drying of the solvent may be suppressed. In addition, the holes provided through the frame component so as to communicate with the flow path may be provided not only to the top surface of the frame component, but also to the sidewall so as to penetrate therethrough, so far it is opened at a level of height above the top surface of the solution.

The substrate 401 in this exemplary embodiment has the cylinder array structure 801 formed in the region corresponded to the bottom surface of the flow path 102. In this way, the surface area inside the flow path 102 may therefore be increased. By making the bottom surface of the flow path 102 lyophilic, the lyophilicity may be increased by virtue of the effect of multiplying the surface area, and thereby the solution may more smoothly be introduced along the cylinder array structure 801, and may stably be retained.

Furthermore, for the case where the sample is dried typically by lyophilization and so forth after the electrophoresis, the sample is obtained in a form of fine powder. However, the cylinder array structure 801 may make the powder less likely to scatter.

Meanwhile, the cylinder array structure 801 also contributes to increase the contact area between the substrate 401 and the solution, so as to suppress Joule heating of the solution in the process of electrophoresis. Accordingly, a larger number of sample solutions may be subjected to electrophoresis, the electrophoresis may be completed within a shorter length of time by setting the applied voltage to a higher value, and proteins and peptides may more sharply be focused on their isoelectric points.

The frame component 402 in this exemplary embodiment has the diaphragms 805, 806 which partition the flow path 102 and the reservoirs 103, 104. On the other hand, the bottom surface of the flow path 102 is provided with the cylinder array structure 801, to thereby have an irregularity formed on the surface of the substrate 401. Accordingly, when the substrate 401 and the frame component 402 are combined, the flow path 102 and the reservoirs 103, 104 are communicated through shallow trenches formed in the substrate 401, so as to allow application of voltage to the sample solution through the electrode solutions, and thereby to enable electrophoresis.

On the other hand, the flow path 102 and the reservoirs 103, 104 are communicated through fine gaps ascribable to the array of cylinders, so that mixing of the solutions between the reservoirs 103, 104 and the flow path 102 may be suppressed. Accordingly, reproducibility of the contact points between the electrode solutions and the sample solution may be improved, and thereby also reproducibility of the electrophoresis may be improved.

In addition, the portions of fine gaps is likely to be heated by Joule heat due to its high resistivity, but is conversely suppressed from excessive elevation in temperature, by virtue of increase in the contact area between the substrate 401 and the solution, contributed by the cylinder array structure 801.

Error in mass analysis may be suppressed to a low level, by adjusting the maximum difference of height of the cylinder array structure 801 formed on the bottom surface of the flow path 102 to 100 μm or smaller.

When macromolecules such as proteins are subjected to mass analysis using a time-of-flight MALDI-MS may be measured by irradiating the macromolecules with laser to ionize them, and measuring the length of time before the accelerated ions are detected. In this process, any positional variation of ionization of the macromolecular sample in the direction of axis of flight may be causative of errors in the mass analysis.

In the time-of-flight MALDI-MS at present, the range of flight of ions generally 1 m or around, yielding a mass error of approximately 1/10000. In other words, positional variation of ionization of macromolecular sample is necessarily suppressed to as small as 1/10000 m, or approximately 100 μm or smaller.

So, by adjusting now the cylinder array structure 801 as high as 100 μm or smaller, the positional variation of ionization of the macromolecular sample may be suppressed to 100 μm or smaller, and thereby a chip excellent in the accuracy of mass analysis may be realized.

Furthermore, the maximum difference of height of the cylinder array structure 801 formed on the bottom surface of the flow path 102 is adjusted to be equal to the size of water drop to be considered, and is possibly adjusted to 1/10 or below of the size of water drop. For an exemplary case where the size of water drop to be considered is 10 μm, the cylinder array structure 801 of micrometer-order height is formed. If the surface area of the substrate, exhibiting a contact angle of 60° or smaller in the flat portion thereof, is doubled by forming the cylinder array structure 801, the region having the cylinder array structure 801 formed therein expresses super-hydrophilicity as predicted from Wenzel's equation, over which water drop will never be formed but infinitely spread.

Moreover, by using a hydrophilic material to the surface of the region of the cylinder array structure 801, the region will be able to express an extremely strong hydrophilicity or super-hydrophilicity, by virtue of the effect of multiplying the surface area in the region of the cylinder array structure 801.

Assuming that the region having the cylinder array structure 801 formed therein expresses super-hydrophilicity, the sample solution introduced into the flow path 102 spreads along the region as a matter of course. As a consequence, the sample solution may infiltrate into the portions below the diaphragms 805, 806 of the frame component 402 and may reach the bottom surface of the reservoirs 103, 104, and may thereby be brought into contact with the electrode solutions. In this case, reservoirs 103, 104 may be configured so as to allow a small amount of solution, only to as enough as wetting the cylinder array structure 801, to infiltrate, even if the level of the top surface of the solution in the flow path were set higher than that of the height of the cylinder array structure 801, by virtue of surface tension ascribable to lyophilicity and lyophobicity, and friction between the cylinder array structure 801 and the solution.

On the other hand, the diaphragms 805, 806 are configured to have a bottle neck structure capable of suppressing mixing of the solutions between the reservoirs 103, 104 containing the electrode solutions and the flow path 102 containing the sample solution. Accordingly, any non-conformities such as dilution of the electrode solutions, and infiltration of a large amount of electrode solutions into the sample solution, may be avoidable. The reproducibility of the isoelectric focusing may therefore be improved.

The cylinder array structure 801 may be formed by arranging the cylindrical components varied in the size and geometry. Alternatively, the cylinder array structure 801 may be formed also by arranging the cylindrical components according to different densities. In this way, the solution may be dried while being locally gathered or segmented, when the sample solution is dried under heating after the electrophoresis.

For example, by forming the cylindrical components in a uniformly aligned manner so as to form the cylinder array structure 801, the solution may uniformly be retained, and may be dried without forming liquid drops. Alternatively, by arranging them while intentionally and locally varying the density and geometry, the solution may be dried in a locally gathered manner or in a segmented manner. Accordingly, the sample may be concentrated by gathering the solution, or a sample fractionation pattern may be retained by segmenting the solution into each position of irradiation of laser, in an early stage of drying.

The cylinder array structure 801 on the bottom surface of the flow path 102 may be adoptable still also when a matrix is added to the sample. The matrix is generally added in a form of solution containing it while being dissolved in a solvent, and the sample and the matrix solution are then mixed and allowed to dry, so as to produce a matrix crystal mixed with the sample. In the process of addition of the solution, the uniform cylinder array structure may uniformly retain the solution and may allow it to dry without forming liquid drops, so as to produce the crystal uniformly over the flow path, so that the uniformity, reproducibility and sensitivity of the measurement may be improved. By arranging the cylinder array structure while further intentionally and locally varying the density and geometry, the solution may be dried while being locally gathered or segmented. Accordingly, the sample may be concentrated by gathering the solution, or a sample fractionation pattern may be retained by segmenting the solution into each position of irradiation of laser, in an early stage of drying.

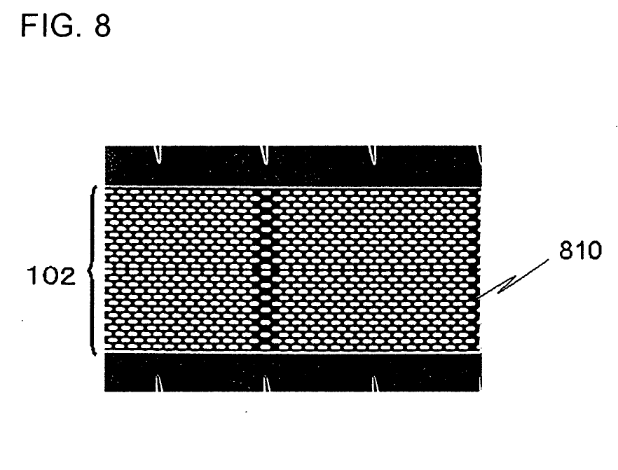

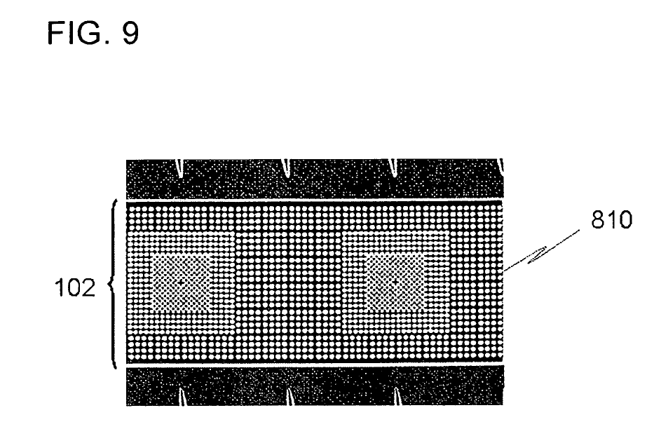

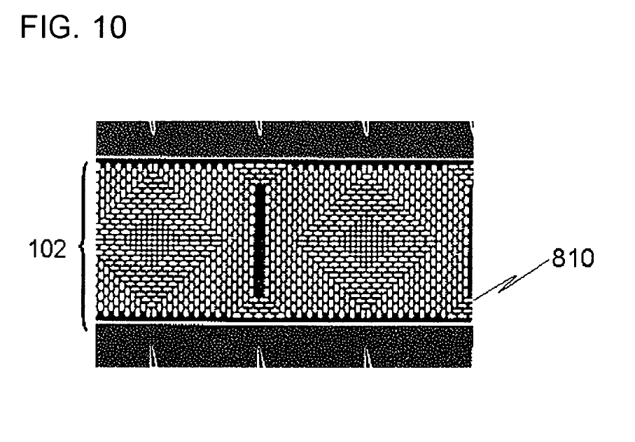

For example, scanning electron microphotographs of the cylinder array structure 810 formed in the flow path, taken from the top of the chip, are shown in FIG. 8 to FIG. 10. In an example shown in FIG. 8, the cylinder array structure 810 has scarce regions formed therein, where water drops are disconnected. On the other hand, in an example shown in FIG. 9, the cylinder array structure 810 has dense regions formed therein. In the process of drying of the solution, water drops may gather in the dense regions and then dried, so that also the solutes are concentrated in these regions. An example shown in FIG. 10 is characterized by both effects of those shown in FIG. 8 and FIG. 9. In the process of drying of the solution and consequent formation of water drops, the water drops may be disconnected at the scarce regions of the cylinder array structure 810. On the other hand, the disconnected water drops are gathered in the dense regions and dried, so as to allow the solutes to deposit in the dense regions.

The exemplary embodiments of the present invention have been described referring to the attached drawings, merely as examples of the present invention, while allowing adoption of any various configurations other than those described in the above.

For example, while the substrate was configured by a flat plate material, and the frame component was configured by a gel-like material in these exemplary embodiments, the substrate may conversely be configured by a gel-like material, and the frame component may be configured by a flat plate material. Furthermore, the substrate and the frame component are not necessarily composed of these materials over the entire portions thereof, so far as they may be brought into close contact, and may be separable.

Meanwhile, the flow path may be configured to be opened over the entire top surface thereof, or may be closed over the entire top surface thereof. Furthermore, for the case where the flow path is closed at the top surface thereof, an opening may be provided thereto. Even for the case where the flow path is closed at the top surface thereof, the top surface of the solution is brought into contact with a gas as illustrated in FIG. 7, and thereby a trench-type flow path may be formed. In addition, for the case where the flow path is closed over the entire top surface, a syringe may be stuck thereinto to inject the solution, or a needle may be stuck thereinto to suck the gas over the top surface of the solution so as to evaporate the solvent.

As the exemplary configuration allowing either one of the frame component and the substrate to engage with the other, this exemplary embodiment has described the configuration such as forming a frame to either one of the substrate and the frame component, and fitting the other to the frame, meanwhile another possible configuration may be such as providing the sidewall on either one of the substrate and the frame component, and engaging the other by horizontally sliding it in parallel to the bottom surface of the flow path.

Meanwhile, the configurations shown in this exemplary embodiment was such as forming the cylinder array structure on the bottom surface of the flow path, wherein the structure may be modified in various ways, so far as the accuracy of mass analysis will not be degraded, that is, so far as the maximum difference of height of the flow path is adjusted to 100 μm or smaller. In addition, this sort of cylinder array structure may be formed also on the sidewall of the flow path.

Meanwhile, the electrophoretic chip of this exemplary embodiment having the trench-type flow path may be configured also so that the portion, other than the portion having the solution reserved therein, is made lyophobic so as to suppress the solution from flooding by the contribution of surface tension.

Meanwhile, the electrophoretic chip described in this exemplary embodiment as adopted to isoelectric focusing, may be adoptable also to other electrophoreses including zone electrophoresis.

Meanwhile, methods of the post-electrophoretic drying of the sample solution may be any known methods so far as they may allow the solvent to vaporize. For example, drying under heating may be preferable for the purpose of allowing the solutes to deposit on the bottom surface, or also lyophilization may be adoptable. If the sample solution is rapidly frozen after the electrophoresis and then lyophilized, a sample in a dried state may be obtained without disturbing a pattern of the sample fractionated in the flow path.

Meanwhile, the frame component, having been described in this exemplary embodiment, was remained attached in the process of addition of the matrix solution, and detached in the process of mass analysis using the MALDI-MS, meanwhile the frame component may be detached when the matrix is added. For example, a large amount of sample may adhere on the sidewall of the flow path composed of the frame component, depending on the method of drying. Thus adhered sample may be dropped onto the bottom surface, by dissolving it or washing it off, using the matrix solution.

Meanwhile, this exemplary embodiment has described the configuration such as moving the bottom surface of the flow path relative to the region of laser irradiation in the process of mass analysis using the MALDI-MS, whereas another possible configuration may be such as moving the region of laser irradiation relative to the bottom surface of the flow path.

In addition, the present invention may adopt also the configurations below.

(1) An electrophoretic chip applied with voltage along a channel filled with a solution containing a sample dissolved therein, so as to allow electrophoresis to proceed therein, to thereby fractionate the sample in the channel; the chip is configured to have the channel having an open-top structure allowing the top surface of the solution to contact with a gas at least in the process of electrophoresis, configured by, at least in the process of electrophoresis, at least two components exhibiting dielectric strength against applied voltage and composed of an electrically-insulating material, the one being a frame component which mainly forms the sidewall of the channel, the other being a substrate which forms the bottom surface of the channel, wherein the frame component is bonded to the substrate so as to be brought into contact therewith, and so as to be detachable from the substrate after the electrophoresis; the chip is further configured to fractionate the sample in the channel, to dry the solution, to add an ionization enhancer to the sample, and then, to be set to a laser desorption/ionization mass spectrometer in which the bottom surface of the channel is scanned with laser so as to detect the mass of the sample, wherein the frame component is detached from the substrate at least before setting to the laser desorption/ionization mass spectrometer, making the chip configured only by the substrate at least at the time of setting onto the laser desorption/ionization mass spectrometer.

(2) The electrophoretic chip as described in (1), wherein, as a configuration allowing the frame component to be bonded to the substrate in a detachable manner, at least either one of the frame component and the substrate forming the bottom surface of the channel has a surface allowing thereon contact between the both, the surface being configured by a material which has adhesiveness, enough to as strong as preventing leaching of the solution, with respect to the surface of the other brought into contact therewith.

(3) The electrophoretic chip as described in (2), wherein the material which has adhesiveness is a gel-like material containing a silicon polymer or an acryl polymer as a major component.

(4) The electrophoretic chip as described in (1), wherein when the chip composed only of the substrate is set to the laser desorption/ionization mass spectrometer, and is scanned with laser along the bottom surface of the channel thereof so as to detect the sample, the bottom surface of the channel irradiated with laser has an irregularity of at least smaller than 100 μm.

(5) The electrophoretic chip having the frame component and the substrate described in (1) provided with alignment mechanisms, allowing alignment between the sidewall of the channel mainly formed by the frame component and the bottom surface of the channel on the substrate, and allowing alignment also between a position of laser irradiation and a position on the bottom surface of the channel to be irradiated by laser, even when only the substrate is set to the laser desorption/ionization mass spectrometer.

(6) The electrophoretic chip having, as the alignment mechanism described in (5), an alignment mark provided to at least either one of the frame component and the substrate.

(7) The electrophoretic chip having, as the alignment mechanism described in (5), a step structure for alignment provided to at least either one of the frame component and the substrate, allowing thereon strike of either one of these components to the other.

(8) The electrophoretic chip having the substrate described in (1) provided with a cylinder array structure at least in the region of the substrate corresponded to the bottom surface of the channel.

1. An electrophoretic chip having a trench-type flow path allowing therethrough electrophoretic migration of a sample to be subjected to mass analysis, said chip comprising:
a reservoir structure in adjacent to said flow path;
a substrate forming the bottom surface of said flow path and the bottom surface of said reservoir structure; and
a frame component provided on said substrate so as to form the sidewall of said flow path and the sidewall of said reservoir structure,
wherein said frame component has at least a part of openings in said flow path,
said substrate and said frame component are separable,
said substrate has a plurality of cylindrical components at least on the bottom surface of said flow path, and
said reservoir structure and said flow path are communicated while placing, in between, a region having an array of said cylindrical components formed therein.

2. The electrophoretic chip as claimed in claim 1,
wherein at least a part of either one of said frame component and said substrate is composed of a material having adhesiveness to the other.

3. The electrophoretic chip as claimed in claim 2,
wherein said material having adhesiveness is a gel-like material containing either one of a silicon polymer and an acryl polymer.

4-10. (canceled)

11. The electrophoretic chip as claimed in claim 1,
wherein said cylindrical components contain those different from each other in either of the size and geometry.

12. The electrophoretic chip as claimed in claim 1,
wherein said cylindrical components are arranged according to different densities.

13. (canceled)

14. (canceled)

15. An electrophoretic chip having a trench-type flow path allowing therethrough electrophoretic migration of a sample to be subjected to mass analysis, said chip comprising:
a substrate forming the bottom surface of said flow path; and
a frame component provided on said substrate so as to form the sidewall of said flow path,
wherein said frame component is formed by using a gel-like material containing either one of a silicon polymer and an acryl polymer, and
said substrate and said frame component are separable.

16. The electrophoretic chip as claimed in claim 1,
wherein either one of said frame component and said substrate has an alignment mark used for alignment between said frame component and said substrate.

17. The electrophoretic chip as claimed in claim 16,
wherein said alignment mark includes a pair of projection and hole engageable with each other,
said projection is provided to either one of said frame component and said substrate, and
said hole is provided to the other corresponding to said projection.

18. The electrophoretic chip as claimed in claim 1,
wherein either one of said frame component and said substrate fits into the other.

19. The electrophoretic chip as claimed in claim 1,
wherein said sidewall of said flow path has a tapered portion.

20. The electrophoretic chip as claimed in claim 1,
wherein the bottom surface of said flow path has a maximum difference of height of 100 μm or smaller.

21. A method of using the electrophoretic chip claimed in claim 1 as a target plate for mass analysis, said method comprising:
a first step which includes:
injecting a solution of said sample into said flow path;
applying voltage along said flow path to thereby fractionate a solution of said sample in said flow path; and
drying said sample, and
a second step setting said sample to a laser desorption/ionization mass spectrometer, irradiating laser
to said sample while moving the bottom surface of said flow path relative to the region of laser irradiation, to thereby detect mass of said sample,
wherein said first step is carried out while combining said substrate and said frame component,
said second step is carried out while detaching said frame component from said substrate, and
said first step is carried out so as to bring the top surface of the solution of said sample retained by said flow path into contact with a gas.
